(19) United States
(12) Patent Application Publication
(10) Pub. No.: US 2021/0033498 A1
(43) Pub. Date: Feb. 4, 2021

(54) MEASUREMENT MODULE FOR CALIBRATING A CONTAINER HANDLING DEVICE

(71) Applicant: KHS GmbH, Dortmund (DE)

(72) Inventors: Sascha Koers, Bergkamen (DE); Markus Reiniger, Mönchengladbach (DE); Miriam Sonnenschein, Dortmund (DE)

(21) Appl. No.: 16/967,172

(22) PCT Filed: Apr. 13, 2018
(86) PCT No.: PCT/EP2018/059588

§ 371 Date: Aug. 4, 2020

(30) Foreign Application Priority Data
Feb. 7, 2018 (DE) 10 2018 102 692.7

(51) Int. Cl. G01M 99/00; G05B 23/02

(52) U.S. Cl. CPC G01M 99/008; G05B 23/0221; G05B 23/0294

(57) ABSTRACT

A measurement puck traverses a treatment path of a container-treatment device that includes plural treatment modules. As it does so, a sensor system within the puck makes contact-free measurements during transfer of the measurement puck between two treatment modules of a container-treatment device. These measurements provide a basis for calibrating the container-treatment device.

### RELATED APPLICATIONS

This is the national stage of international application PCT/EP2018/059588, which claims the benefit of the Feb. 7, 2018 priority date of German application DE 102018102692.7, the contents of which are herein incorporated by reference.

### FIELD OF INVENTION

The invention relates to container-treatment, and in particular, to container-treatment machines in which a container is moved from one treatment module to another along a treatment path.

### BACKGROUND

Many container-treatment machines have different modules in which different tasks are performed. The container-treatment procedure thus includes moving the container from one module to the next.

As the container moves through the different treatment stations, it is constantly undergoing accelerations. These cause forces that disturb the precise alignment of the container. When printing on a container, such small perturbations cause noticeable distortions in the printed image.

### SUMMARY

The object of the present invention is therefore to provide improved calibration for a container treatment device with at least two treatment modules, with which, in particular, the transfer procedures can be more precisely controlled and/or regulated in comparison with the known prior art.

According to a first aspect, the invention relates to a measurement module for calibrating a container treatment device with at least two treatment modules, which are provided along a treatment path. In this situation, the treatment module according to the invention comprises at least one rotationally symmetrical main body, at least one sensor unit, and a control and/or evaluation unit connected to the sensor unit, and a power supply unit. In this situation, the main body is configured for clamping and/or magnetic fixing during transport along the treatment path, inside as well as between the treatment modules. Furthermore, by means of the at least one sensor unit, characteristic values and/or parameters which arise in the region of the main body and/or take effect on the main body can be detected by means of a measurement routine carried out in the control and/or evaluation unit, free of contact, at least during the transfer procedures between the treatment modules. Accordingly, according to the invention a measurement module is provided which recreates the holding and centering unit, i.e. the puck, by means of the main body, and therefore, instead of the puck, can be transported through the at least two treatment modules of the container treatment device in order to detect the real system-specific conditions along the treatment path, which in regular operation of the container treatment device would otherwise have had an effect on the puck. From the characteristic values and/or parameters which are acquired in such a way, system-specific control and/or regulating data for the respective container treatment device can be generated, and therefore the transfer procedures between the treatment modules for the actual puck transfer during regular operation can be calibrated on the basis of the characteristic values and/or parameters detected by the measurement module according to the invention. A further advantage is that the measurement module operates free of contact, and can therefore be transported through the container treatment device in the same way as any puck known from the prior art. Accordingly, no elaborate transfusion model needs to be applied for the calibration of the container treatment device, and instead the data acquired by means of the measurement module according to the invention can be used directly and transferred to a puck.

According to one advantageous embodiment variant, provision can be made for the main body to comprise a fixing-and-measurement section, by means of which the measurement module can be fixed to the container treatment device and is configured so as to accommodate the at least one sensor unit, in such a way that characteristic values and/or parameters can be detected which take effect on the main body in the region of the fixing-and-measurement section.

According to a further advantageous embodiment variant, provision can be made for the main body to be configured as essentially circular in cross-section in the region of the fixing-and-measurement section and extends radially along the module longitudinal axis.

According to a further advantageous embodiment variant, provision can be made in this situation for the fixing and measuring part section to comprise a first fixing-and-measurement section, a second fixing-and-measurement section, and a third fixing-and-measurement section, wherein the fixing-and-measurement sections are provided in each case spaced at a distance from one another along the module longitudinal axis.

According to a further advantageous embodiment variant, provision can be made in this situation for the first fixing and measuring part section to be configured as an upper ring section, which comprises at least one first holding ring, as well as the at least one first sensor unit, which is provided between the first holding ring and the main body.

According to a further advantageous embodiment variant, provision can be made in this situation for the first fixing and measuring part section is mounted by means of a first holding means in a first slot-shaped cut-out opening, formed in the main body and running circumferentially and radially around the module longitudinal axis.

According to a further advantageous embodiment variant, provision can be made in this situation for the at least one first sensor unit to be configured as a force detector, in such a way that, by means of the at least one sensor unit, a force which takes effect in the region of the first fixing and measuring part section can be detected as a characteristic value and/or parameter.

According to a further advantageous embodiment variant, provision can be made in this situation for the first fixing and measuring part section to comprise several first sensor units, which are provided oriented at approximately equal angular distances about the module longitudinal axis, and are connected in each case by a separate first holding means to the module housing.

According to a further advantageous embodiment variant, provision can be made in this situation for the second fixing and measuring part section to be configured as a middle ring section, which comprises at least one second holding ring as well as the at least one second sensor unit, which is provided between the second holding ring and the main body.

According to a further advantageous embodiment variant, provision can be made in this situation for the second holding ring to be formed at least in sections, and preferably completely, from a ferromagnetic material.

According to a further advantageous embodiment variant, provision can be made in this situation for the second fixing and measuring part section to be mounted by means of a second holding means in a second slot-shaped cut-out opening formed in the main body and running circumferentially and radially around the module longitudinal axis.

According to a further advantageous embodiment variant, provision can be made in this situation for the at least one second sensor unit to be configured as a force detector, in such a way that, by means of the at least one second sensor unit, a force which takes effect in the region of the first fixing and measuring part section can be detected as a characteristic value and/or parameter.

According to a further advantageous embodiment variant, provision can be made in this situation for the second fixing and measuring part section to comprise several second sensor units, which are provided oriented at approximately equal angular distances about the module longitudinal axis, and are connected in each case by a separate first holding means to the module housing.

According to a further advantageous embodiment variant, provision can be made in this situation for the third fixing and measuring part section to be configured as a lower ring section, which comprises at least one third holding ring, as well as the at least one third sensor unit, which is provided between the third holding ring and the main body.

According to a further advantageous embodiment variant, provision can be made in this situation for the third fixing and measurement part section to be mounted by means of a third holding means in a third slot-shaped cut-out opening formed in the main body and running circumferentially and radially around the module longitudinal axis.

According to a further advantageous embodiment variant, provision can be made in this situation for the at least one third sensor unit to be configured as a force detector, in such a way that, by means of the at least one third sensor unit, a force which takes effect in the region of the third fixing and measuring part section can be detected as a characteristic value and/or parameter.

According to a further advantageous embodiment variant, provision can be made in this situation for the third fixing and measuring part to comprise several third sensor units, which are provided oriented at approximately equal angular distances about the module longitudinal axis, and are connected in each case by a separate third holding means to the module housing.

According to a further advantageous embodiment variant, provision can be made in this situation for the main body to comprise a free inner space to accommodate the control-and-evaluation unit, hereafter “controller,” and the power supply unit, hereafter, the “power supply.”

According to a further advantageous embodiment variant, provision can be made in this situation for the control and evaluation unit to comprise a memory storage unit, or “memory,” for storing the characteristic values and/or parameters which are detected.

According to a further advantageous embodiment variant, provision can be made in this situation for at least one fourth sensor unit to be provided in the free inner space of the main body, which is configured as an acceleration sensor for detecting acceleration values which take effect on the module housing as characteristic values and/or parameters.

According to a further advantageous embodiment variant, provision can be made in this situation for at least two fourth sensor units, configured as acceleration sensors, to be formed in the free inner space, wherein a fourth sensor unit is provided in the region of an upper side of the main body, and the at least one further fourth sensor unit is provided in the region of an under side of the main body.

According to a further advantageous embodiment variant, provision can be made in this situation for the characteristic values and/or parameters to be detected as time-dependent and/or location-dependent.

According to a further advantageous embodiment variant, provision can be made in this situation for the measurement module to have a mass of 2.5 kg to 3 kg, and particularly advantageously of 2.68 kg.

The expression “essentially” or “approximately” in the meaning of the invention signifies deviations from the exact value in each case by +/−10%, preferably by +/−5%, and/or deviations in the form of changes which are not of significance for the function.

Further embodiments, advantages, and possible applications of the invention are also derived from the following description of exemplary embodiments and from the Figures. In this situation, all the features described and/or pictorially represented are in principle the object of the invention, individually or in any desired combination, regardless of their inclusion in the claims or reference to them. The contents of the claims are also a constituent part of the description.

### BRIEF DESCRIPTION OF THE DRAWINGS

The invention is described in greater detail hereinafter on the basis of the Figures by reference to exemplary embodiments. The Figures show:

FIG. 1 shows a container treatment machine comprising several modules;

FIG. 2a shows a top view of the container-treatment machine of FIG. 1; FIG. 2b shows a transport path through the container-treatment machine of FIG. 1;

FIG. 3 shows a transport puck used in the container-treatment machine of FIG. 1;

FIG. 4 shows a measurement puck arranged on a fixing device;

FIG. 5 shows a circuit for the measurement puck of FIG. 4;

FIG. 6a shows a perspective view of the measurement puck of FIG. 4;

FIG. 6b shows a side view of the measurement puck of FIG. 4;

FIG. 7a shows a sectional side-view of the measurement puck of FIG. 7a; and FIGS. 7b-7d are sectional views from above at planes corresponding to first, second, and third fixing-and-measurement section, respectively.

Identical reference numbers are used in the Figures for elements of the invention which are the same or have the same effect. In addition, for the sake of easier overview, only reference numbers are represented in the individual Figures which are required for the description of the respective Figure.

### DETAILED DESCRIPTION

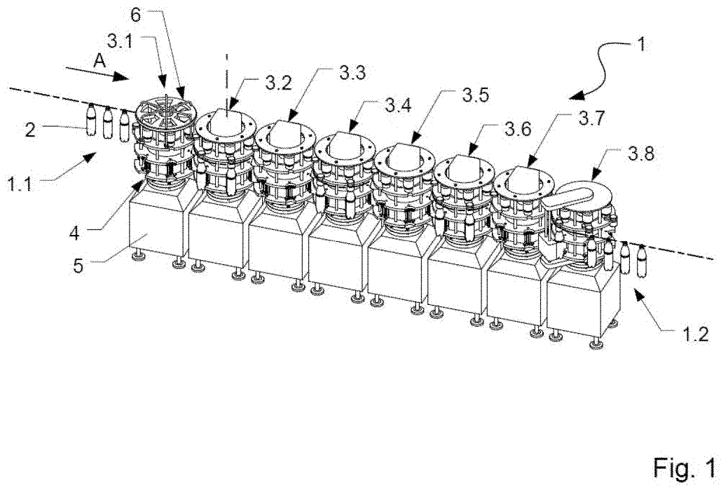

FIG. 1 shows a container-treatment machine 1 that prints on container 2, such as bottles. The container-treatment machine prints on either a bottle's casing or on a label applied to the bottle. In some embodiments, the container-printing machine 1 relies on inkjet printers.

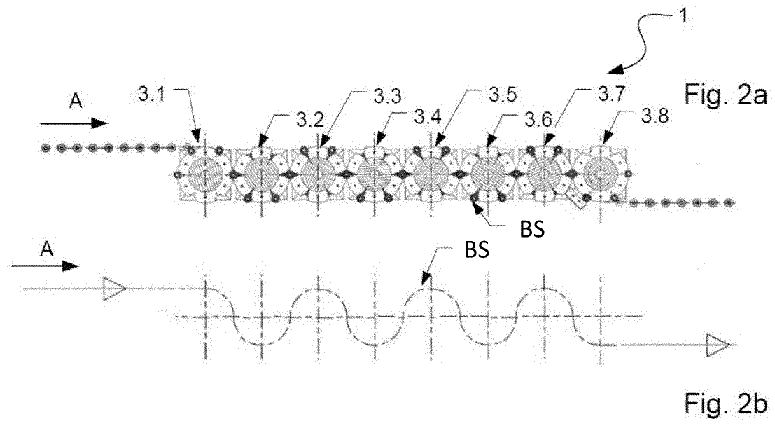

In operation, an external transporter transports upright containers along a transport path “A” to a container inlet 1.1 of the container-treatment machine 1. The containers move along a meandering treatment path BS, best seen in FIG. 2a and FIG. 2b. After having been printed upon, the containers leave at a container outlet 1.2.

The container-treatment machine 1 includes treatment modules 3.1-3.n that connect directly with each other along the transport direction to form a line of treatment modules 3.1-3.n. In the illustrated embodiment, there are a total of eight treatment modules 3.1-3.8. It is understood that, depending on the application situation, more or fewer treatment modules can be provided.

The treatment modules 3.1-3.8 are formed from identical base units 4 that have been equipped different kinds of function elements depending on the task of that treatment module 3.1-3.8.

Referring back to FIG. 1, each base 4 has main body 5 and a transport element 6 disposed on the main body. The housing contains a drive and a controller for the base unit 4. The transport element 6 rotates about a vertical machine axis MA.

A transport element 6 is configured to have plural treatments units of the identical type mounted along its circumference. Each treatment unit defines a treatment station that performs one of several tasks required for complete treatment of the container.

As an example, some treatment units carry out preliminary steps, such as sterilizing containers. Others are detection units that search for particular container features. Others are printing units that carry out the actual printing using, in many cases, inkjet printers. Still others are post-treatment units that carry out such tasks as curing, drying, and inspection.

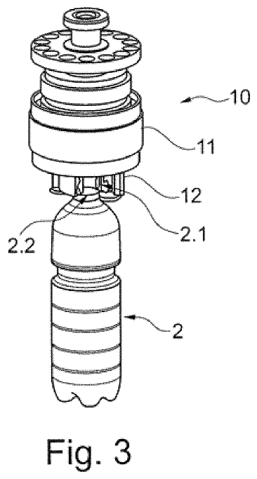

FIG. 3 shows a holding-and-centering unit, or transport puck 10, that receives a container at the container inlet 1.1 and holds that container as it traverses the various treatment modules. The transport puck 10 releases the container at the container outlet 1.2 and then goes back to the container inlet 1.1 to pick up a new container.

Each treatment station receives a transport puck 10 and holds that transport puck 10 for the duration of its treatment within that treatment station and releases the transport puck 10 at the end of the treatment. Between two treatment modules, the treatment station releases the transport puck 10 it faces a treatment station of another treatment module that is ready to receive the puck 10.

Referring now to FIG. 2a, the transport elements 6 of the individual treatment modules 3.1-3.8 are arranged so that each transport element has a point of tangency with another transport element at which an upstream transport element releases a transport puck 10 and a downstream transport element receives the transport puck 10. The transport elements 6 rotate synchronously but in opposite directions. A transport puck 10 therefore traverses the meandering path shown in FIG. 2b on its way from the container inlet 1.1 to the container outlet 1.2. Returning now to FIG. 3, the transport puck 10 includes a fixing section 11 that is intended to be fixed to the transport element 6 for the duration of the puck's visit to that transport element 6. The force that fixes it in position is either a mechanical force or an electromagnetic force.

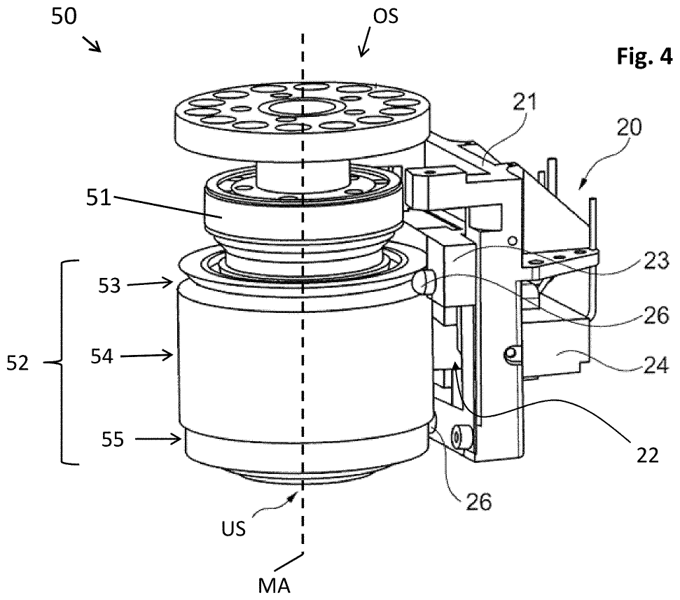

In the illustrated embodiment, the fixing section 11 has a circular cross section that projects radially outward in relation to other sections of the transport puck 10. As a result, when the fixing section 11 engages a fixing device 20, seen in FIG. 4, the puck's position is precisely fixed. This is particularly important for printing, since even slight changes in position will yield noticeable distortions in printed images.

FIG. 4 shows a measurement puck 50 that engages the fixing section 11 in the same way as the transport puck 10. However, the measurement puck 50 does not transport a container. Its purpose is to measure parameters indicative of what the transport puck 10 would have experienced as it traversed the treatment path BS.

The measurement puck 50 further comprises a rotationally-symmetric main body 51 having an upper side OS and an underside US. These correspond to the upper side and underside of the measurement puck 50. As shown in the figure, the main body 51 is rotationally symmetric about a longitudinal axis MA that extends through the center of the main body 51.

The main body 51 is used for fixing the measurement puck 50 during transport along the treatment path and between treatment modules 3.1-3.8. Embodiments include those in which the main body 51 is clamped and those in which it is held by a magnetic force.

The measurement puck 50 is configured such as to be arranged at the fixing device 20 and to in effect mimic the movement of the transport puck 10 and to experience what a transport puck 10 would have experienced as it is transferred from one fixing device 20 to the next. However, unlike the transport puck 10, the measurement puck 50 records its experiences.

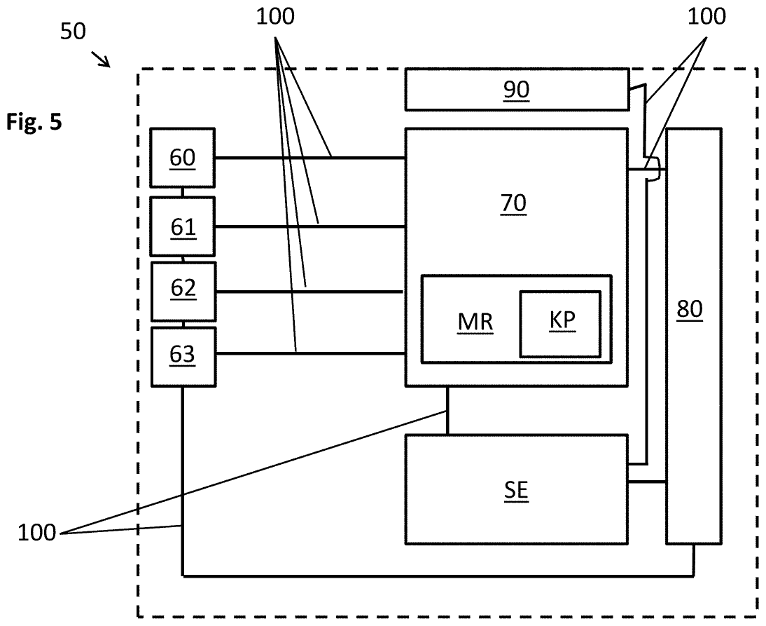

The main body 51 accommodates one or more sensors 60, 61, 62, 63, a controller 70, and a power supply 80, which are shown in the circuit diagram of FIG. 5. A suitable power supply 80 is a rechargeable battery or accumulator.

The controller 70 and the power supply unit 80 are accommodated in a free inner space of the main body 51. The sensors 60, 61, 62, 63 can be either inside the inner space IR or outside depending on the nature of the sensor. In some embodiments, the inner space also accommodates a user interface 90 that interacts with the controller 70.

Each sensor 60, 61, 62, 63 carries out a contactless measurement to collect calibration information KP that is useful for calibrating the operation of the various treatment modules 3.1-3.8. This calibration information KP includes information indicative of characteristic values and/or parameters concerning events that occur in the region of the module's main body 51 as the sensor puck 50 makes its journey along the treatment path BS. Of particular importance is information collected during transfer between the treatment modules 3.1-3.8. This calibration information KP is provided to a measurement routine MR in the controller 70.

The controller 70 comprises a memory SE for storing the calibration information KP so that they can be read out by the user interface 90. Electrical connectors 100 interconnect the various components shown in FIG. 5.

The main body 51 comprises a fixing-and-measurement section 52. As shown in FIG. 4, the fixing device 20 engages the fixing-and-measurement section 52. The fixing-and-measurement section 52 accommodates the components shown in FIG. 5. In some embodiments, the fixing-and-measurement section 52 is formed from first, second, and third subsections 53, 54, 55 that are arranged along the longitudinal axis MA.

A carrier 21 connects the fixing device 20 to the treatment station. The fixing device 20 includes a fixing section 22 that engages either the measurement puck 50 or the transport puck 10, can be fixed in a detachable manner in a detachable manner. In some embodiments, the fixing section 22 includes an electromagnet that interacts with the fixing-and-measurement section 52 of the main body 51 so as to use by magnetic attraction to fix the measurement puck 50 in relation to the treatment station 8 in a detachable manner.

As can be seen from FIGS. 4, 6a, 6b, and 7, the first subsection 53 is an upper ring section, the second fixing subsection 54 is a middle ring section, and the third subsection 55 is a lower ring section. Every one of the three subsections 53-55 is configured both for the precisely positioned fixing of the measurement puck 50, in particular of the main body 51, to a respective fixing device 20 as well as for the contact-free detection and/or measurement of characteristic values and/or parameters for use in the calibration information KP. This information concerns events that occur during transfer between the treatment modules 3.1-3.8 in the region of the main body 51 and/or events that exert and affect the main body 51.

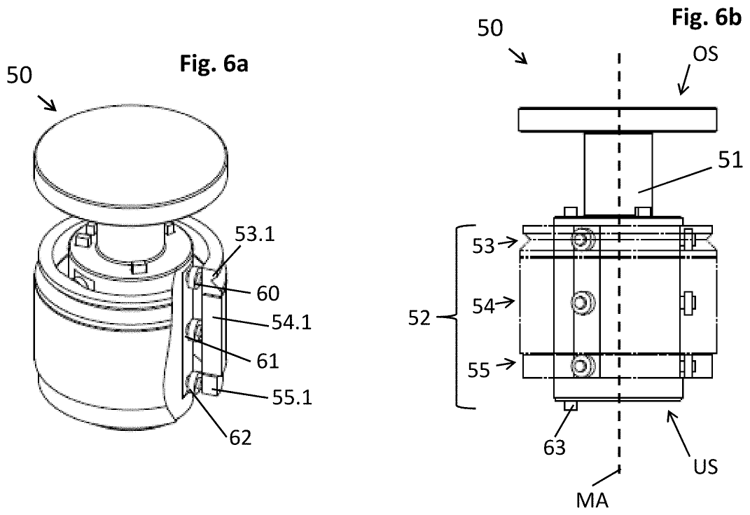

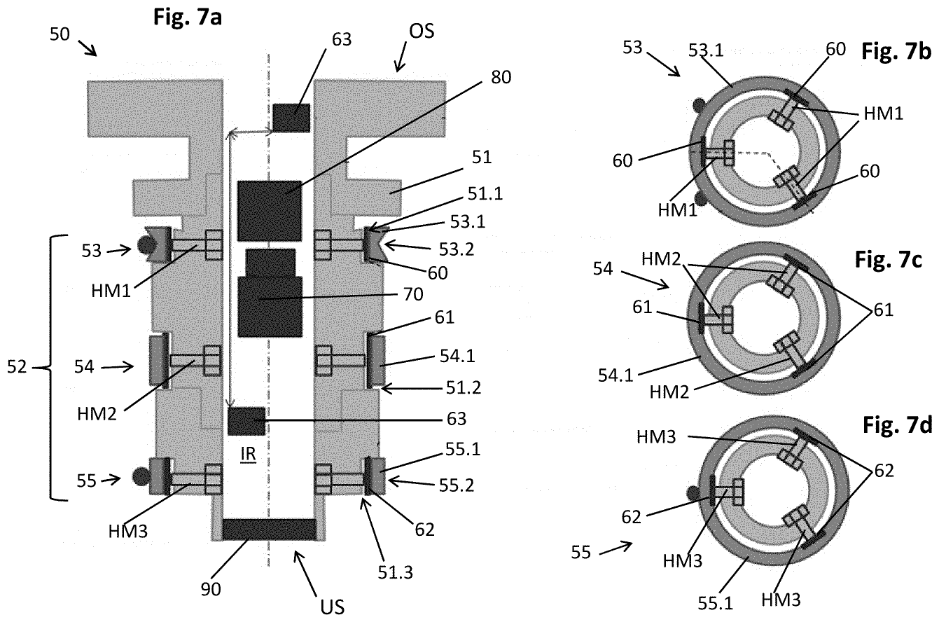

Referring to FIG. 6a, the first subsection 53 comprises a first holding ring 53.1 and a sensor 60 between the first holding ring 53.1 and the main body 51. In some embodiments, the first subsection 53 is a ring section over at least part of the main body's circumference. However, in others, it extends over the main body's entire circumference and encloses the longitudinal axis MA. The first holding ring 53.1 is nestled in a slot-shaped first cut-out opening 51.1 in the main body 51, best seen in FIG. 7a.

The slot-shaped first cut-out opening 51.1 is as an indentation in the direction of the module longitudinal axis MA. This indentation forms a groove in the main body 51 that surrounds the longitudinal axis MA.

The second subsection 54 connects to the main body 51 by using a first holder HM1. In some embodiments, the first holder HM1 comprises a holding pin.

The second sensor 60 is arranged between the first holder HM1 and the first holding ring 53.1. In the illustrated embodiment, the second sensor 60 is a force sensor.

As shown in FIG. 7b-7c, each sensor 60, 61, 62 comprises three measurement points that are separated by equal angular distances and connected by separate holders HM1 to the main body 51.

Some embodiments feature a cut-out opening 53.2 or indentation in the form of a slot that extends around an outer surface of the first holding ring 53.1 for engaging with projections 26 from the moving receiver unit 23 of the fixing device 20, as shown in FIG. 4. The engagement of the cut-out opening 53.2 with the projections 26 promotes more precise placement of the measurement puck.

In some embodiments, the projections 26 interact with corresponding cut-out openings 53.2 or indentations in the first holding ring 53.1 of the first subsection 53 of the main body 51. Among these embodiments are those in which the projections 26 are hemispherical.

The second subsection 54 is a ring section that also comprises a holding ring, hereafter the “second holding ring 54.1” and a sensor, hereafter the “second sensor” 61. The second sensor 61 lies between the second holding ring 54.1 and the main body 51.

Advantageously, the second subsection 54 can be provided along the module longitudinal axis MA, spaced at a distance interval from the first subsection 53. In this situation the second holding ring 54.1 is formed at least in sections, and preferably entirely, from a ferromagnetic material. Due to the formation of the second holding ring 54.1 from ferromagnetic material, the main body 51 can be fixed at least by the second holding ring 54.1 magnetically to the fixing device 20.

The second subsection 54, formed as a ring section, is configured such as to run around the module longitudinal axis MA at least over part of the circumference, but for preference over the full circumference, and in this situation is provided preferably in a second cut-out opening 51.2, in the form of a slot at the main body 51.

The second cut-out opening 51.2, in the form of a slot, is configured as an indentation reverting towards the outer casing surface of the main body 51 in the direction of the module longitudinal axis MA, in the form of a groove in the main body 51 circulating radially about the module longitudinal axis MA. In this situation, the second slot-shaped cut-out opening 51.2 is provided spaced at a distance from the first slot-shaped cut-out opening 51.2, along the module longitudinal axis MA.

Likewise, the second subsection 54 is connected by means of at least one second holding means HM2, which can be configured, for example, as a holding pin, to the main body 51. In particular, in this situation the at least one second sensor unit 61 is arranged between the at least one second holding means HM2 and the second holding ring 54.1, and is configured as a force detector. As a result, it is also possible, by means of the at least one second sensor unit 61, configured as a force detector, for a force to be detected which takes effect on the main body 51 in the region of the second subsection 54 of the fixing-and-measurement section 52 to be detected as a characteristic value and/or parameter KP.

Preferably, in this situation the second fixing-and-measurement section 54 also comprises several second sensor units 61, for example three, which are provided oriented at the same or approximately the same angular distances about the module longitudinal axis MA, and are connected in each case by a separate second holding means HM2 to the main body 51.

Likewise, the third subsection 55, configured as a ring section, comprises at least one third holding ring 55.1 as well as at least one third sensor unit 62, which is provided between the third holding ring 55.1 and main body 51.

Advantageously, the third subsection 55 is provided along the module longitudinal axis MA, spaced at a distance from the second subsection 54, which in turn is provided spaced at a distance from the first subsection 53.

The fourth subsection 55, configured as a ring section, is configured such as to run around the module longitudinal axis MA at least over part of the circumference, but preferably over the full circumference, and in this situation is preferably provided in a third cut-out opening 51.3 in the form of a slot at the main body 51. The third cut-out opening 51.3 in the form of a slot is configured as an indentation reverting towards the outer casing surface of the main body 51, in the direction of the module longitudinal axis MA, in the form of a groove in the main body 51 circulating radially about the module longitudinal axis MA.

In this embodiment, the third subsection 55 is connected to the main body 51 by a third holder HM3, which can be configured, for example, as a holding pin. In particular, in this situation the at least one third sensor unit 62 is arranged between the at least one third holder HM3 and the third holding ring 55.1 and is configured as a force detector. As a result, by means of the at least one third sensor unit 62, configured as a force detector, a force which takes effect on the main body 51 in the region of the third subsection 55 of the fixing-and-measurement section 52 to be detected as a characteristic value and/or parameter KP.

Preferably, in this situation the third fixing-and-measurement section 55 also comprises several measurement points 62, for example three, which are provided oriented at the same or approximately the same angular distances about the module longitudinal axis MA and are connected in each case by a separate second holding means HM2 to the main body 51.

It is also possible for a cut-out opening 55.2 or indentation in the form of a slot running circumferentially to be provided on the outside of the third holding ring 55.1, into which several projections 26 can engage at the fixing device 20, in particular at the moving receiver unit 23 of the fixing device 20, in order to provide the precisely positioned receiving of the measurement puck 50 at the fixing device 20.

The first and third holding rings 53.1 and 55.1 are provided spaced at a distance apart along the module longitudinal axis MA in such a way that the first holding ring 53.1 can be brought into engagement with the upper at least two projections 26 and the third holding ring 55.1 can be brought into engagement with the lower projection 26 of the fixing device 20.

Furthermore, provided in the free inner space IR of the main body 51 is the at least one fourth sensor unit 63, which can be configured as an acceleration sensor. By means of the at least one fourth sensor unit 63, configured as an acceleration sensor, it is then possible to detect the acceleration taking effect on the main body 51 as a characteristic value and/or parameter KP.

Preferably, in this situation at least two fourth sensor units 63, configured as acceleration sensors can be provided in the free inner space IR, wherein a fourth sensor unit 63 is provided in the region of the upper side OS of the main body 51 and the at least one fourth sensor unit 63 is provided in the region of the underside US of the main body 51.

In some embodiments, the measurement puck 50 collects characteristic values and/or parameters that vary with time or location or both. To achieve this, the measurement puck 50 features a synchronization mechanism that enables tagging of data with the time at which it was acquired or the location at which it was acquired. To improve the realism of the calibration data, it is useful to have the measurement puck 50 do all the same things that the transport pucks 10 would do as they traverse the machine.

Preferably, the measurement module (1) can be used for a treatment device or its treatment modules (3.1-3.8), which comprises at least one printing head, and preferably a plurality of printing heads, and is configured for the digital printing of containers by means of an inkjet method and process, with the transport method referred to heretofore by means of transport pucks 10. For this purpose, the measurement module corresponds with the sectional dimensions of its outer geometry, which come in contact during transport with the elements of a treatment module (3.1-3.8), to those of the transport pucks 10 which are also used in operation of the system as specified.

It is particularly useful for the mass of a measurement puck 50 to be close to or equal to the mass of a transport puck 10. A useful range is between 2.5 and 3 kilograms. A particularly useful mass is one that is equal to 2.68 kilograms, which corresponds to the mass of a typical transport puck 10, i.e. a puck. The invention has been described heretofore by way of exemplary embodiments. It is understood that a large number of modifications or derivations are possible without thereby departing from the scope of protection of the invention defined by the claims.

1-27. (canceled)

28. An apparatus comprising a measurement puck for calibrating a container-treatment device that comprises treatment modules that are along a treatment path that is traversed by a container that is treated at said treatment modules, wherein said measurement puck comprises a main body, a sensor system, a controller, and a power supply, wherein said controller is in communication with said sensor system, wherein said main body is configured for being fixed to a treatment module as said measurement puck as said puck traverses said treatment modules along said treatment path, wherein, said sensor system is configured to make a contact-free measurement of data during transfer of said measurement puck between two treatment modules, said data including a characteristic value or parameter, and wherein said controller receives said measurement and executes a measurement routine to process said measurement.

29. The apparatus of claim 28, wherein said main body comprises a fixing-and-measurement section that enables said measurement puck to be fixed to said container-treatment device and wherein said sensor system comprises a first sensor that is mounted in said fixing-and-measurement section, whereby said first sensor measures said data at said main body.

30. The apparatus of claim 28, wherein, at a fixing-and-measurement section thereof, said main body has a circular cross-section and extends along a longitudinal axis of said measurement puck.

31. The apparatus of claim 28, wherein said sensor system comprises a sensor that measures at least one of force and acceleration.

32. The apparatus of claim 28, wherein said main body comprises a fixing-and-measurement section that enables said measurement puck to be fixed to said container-treatment device and wherein said fixing-and-measurement section comprises first, second, third, and fourth subsections that are spaced apart from each other along a longitudinal axis of said measurement puck.

33. The apparatus of claim 28, wherein said main body comprises a fixing-and-measurement section that enables said measurement puck to be fixed to said container-treatment device, wherein said fixing-and-measurement section comprises an upper ring section that comprises a holding ring, and wherein said sensor system comprises a sensor that is disposed between said holding ring and said main body.

34. The apparatus of claim 28, wherein said main body comprises a fixing-and-measurement section that enables said measurement puck to be fixed to said container-treatment device, wherein said fixing-and-measurement section comprises a subsection and a holder, and wherein said holder mounts said subsection at a slot-shaped first cut-out opening formed in said main body and running radially and circumferentially about a longitudinal axis of said measurement puck.

35. The apparatus of claim 28, wherein said sensor system comprises a force detector that measures a force that takes effect at a fixing-and-measurement section that enables said measurement puck to be fixed to said container-treatment device.

36. The apparatus of claim 28, further comprising holders, wherein said sensor system comprises a sensor that comprises plural measurement points that are oriented at equal angular distances around an axis of said measurement puck, and wherein said holders connect said measurement points to said main body.

37. The apparatus of claim 28, wherein said sensor system comprises first and second sensors, wherein said main body comprises first and second subsections each comprising corresponding first and second ring sections and first and second holding rings, wherein said first sensor is between said main body and said first holding ring, and wherein said second sensor is between said main body and said second holding ring.

38. The apparatus of claim 28, wherein said main body comprises a fixing-and-measurement section that enables said measurement puck to be fixed to said container-treatment device, wherein said fixing-and-measurement section comprises first and second subsections that are spaced apart from each other along a longitudinal axis of said measurement puck, wherein said first and second subsections comprise corresponding first and second holding rings, and wherein said second holding ring is formed, at least in sections, completely from a ferromagnetic material.

39. The apparatus of claim 28, wherein said main body comprises a fixing-and-measurement section that enables said measurement puck to be fixed to said container-treatment device, wherein said fixing-and-measurement section comprises first and second subsections that are spaced apart from each other along a longitudinal axis of said measurement puck, wherein said first and second subsections comprise corresponding first and second holding rings, and wherein a holder mounts said second subsection in a slot-shaped second cut-out opening formed in said main body, said opening extending circumferentially around an axis of said measurement puck.

40. The apparatus of claim 28, wherein said sensor system comprises first and second sensors, wherein said main body comprises a fixing-and-measurement section that enables said measurement puck to be fixed to said container-treatment device, wherein said fixing-and-measurement section comprises first and second subsections that are spaced apart from each other along a longitudinal axis of said measurement puck, wherein said first and second sensors are disposed in said first and second subsections, wherein said second sensor is a force detector that measures a force taking effect in a region of said second subsection, wherein said force is a constituent of said data.

41. The apparatus of claim 28, further comprising holders, wherein said sensor system comprises first and second sensors, wherein said main body comprises a fixing-and-measurement section that enables said measurement puck to be fixed to said container-treatment device, wherein said fixing-and-measurement section comprises first and second subsections that are spaced apart from each other along a longitudinal axis of said measurement puck, wherein said first and second sensors are disposed in said first and second subsections, wherein said second sensor comprises several measurement points oriented at approximately equal angular distances about an axis of said measurement puck, and wherein said holders connect said measurement points to said main body.

42. The apparatus of claim 28, wherein said sensor system comprises first, second, and third sensors, wherein said main body comprises a fixing-and-measurement section that enables said measurement puck to be fixed to said container-treatment device, wherein said fixing-and-measurement section comprises first, second, and third subsections that are spaced apart from each other along a longitudinal axis of said measurement puck, wherein said first, second, and third sensors are disposed in said first, second, and third subsections respectively, wherein each of said subjections comprises a holding ring, wherein each of said sensors is between said main body and a corresponding one of said holding rings.

43. The apparatus of claim 28, wherein said sensor system includes an acceleration sensor.

44. The apparatus of claim 28, wherein said sensor system comprises acceleration sensors disposed inside said main body, on an upper side of said main body, and on an under side of said main body and wherein at least two of said acceleration sensors are in said main body.

45. The apparatus of claim 28, wherein said measurement puck is configured to measure time-varying and location-varying data and to identify when and where said data was measured.

46. The apparatus of claim 28, wherein said measurement puck has rotational symmetry.

47. A method comprising calibrating a container-treatment device that comprises treatment modules that are disposed along a treatment path, wherein calibrating said container-treatment device comprises introducing a measurement puck into said container-treatment device, wherein said measurement puck uses a sensor to make contact-free measurements of a parameter during transfer of said measurement puck from one treatment module to another, receiving said measurements, and processing said measurements to obtain calibration data concerning said container-treatment device.
